(19) United States
(12) Patent Application Publication
(10) Pub. No.: US 2025/0206424 A1
(43) Pub. Date: Jun. 26, 2025

(54) Expanding Structure for Cylinder Internal Unit and Cylinder Internal Unit

(71) Applicant: HMN Technologies Co., Limited, Tianjin (CN)

(72) Inventors: Wenjuan MEI, Tianjin (CN); Ge JIN, Tianjin (CN); Weidong WU, Tianjin (CN); Jitao ZHAI, Tianjin (CN); Yanqi HOU, Tianjin (CN); Yong LIU, Tianjin (CN)

(21) Appl. No.: 18/590,100

(22) Filed: Feb. 28, 2024

(30) Foreign Application Priority Data
Dec. 26, 2023 (CN) 202311798078.8

(51) Int. Cl. B63G 8/38; F16B 7/04; H01Q 1/34

(52) U.S. Cl. CPC B63G 8/38; F16B 7/0413; H01Q 1/34

(57) ABSTRACT

An expanding structure for a cylinder internal unit and a cylinder internal unit are provided. The expanding structure includes a first expanding structure arranged at an end of an internal unit and a second expanding structure arranged on a side wall of the internal unit. The first expanding structure includes a plurality of first expanding assemblies arranged at intervals in a circumferential direction of the base. The second expanding structure includes a plurality of second expanding assemblies arranged at intervals in a circumferential direction of the internal unit. With coordination of the first expanding structure and the second expanding structure, strength required for expanding can be achieved, and uniform expansion of the end and the side wall of the internal unit can be achieved in the expanding process. The expanding structure is easy to be assembled and disassembled, the operation is simple, and operation efficiency is effectively improved.

This application claims priority to Chinese Patent Application No. 202311798078.8, filed on Dec. 26, 2023, which is incorporated herein by reference in its entirety.

### FIELD OF THE INVENTION

This application relates to the field of submarine communication technology, and in particular to an expanding structure for a cylinder internal unit (or an internal unit within a cylinder) and a cylinder internal unit.

### BACKGROUND OF THE INVENTION

The underwater communication and underwater monitoring technology have developed rapidly in recent years, and they typically employ underwater products to achieve communication or monitoring operation. The underwater product generally includes an internal unit and an external pressure-bearing cylinder. The internal unit is provided with an expanding structure for supporting the internal unit within the external pressure-bearing cylinder. After the internal unit enters the external pressure-bearing cylinder, the gap between the internal unit and the pressure-bearing cylinder should be adjusted. With the expanding structure, it can ensure that the internal unit is evenly supported in the pressure-bearing cylinder.

The underwater product is usually in a thick-walled cylindrical structure so as to ensure mechanical strength and corrosion resistance. The expanding structure, as connection between the internal unit composed of internal core components of the underwater equipment and the external pressure-bearing cylinder, is especially important.

The existing expanding structure generally needs to be symmetrically arranged at two ends of the internal unit to meet the expanding conditions. In the expanding process, if one side is unevenly stressed, the screw is easily stuck, which would affect the expanding effect. In addition, the existing expanding structure is difficult to be assembled and disassembled, which also affects the operation efficiency.

### SUMMARY OF THE INVENTION

An expanding structure for a cylinder internal unit and a cylinder internal unit are provided according to this application, aiming to solve such technical problem as the expanding effect of the existing expanding structure being affected due to unevenly stressed, the existing expanding structure being difficult to be assembled and disassembled, and the operation efficiency being low.

In a first aspect of this application, an expanding structure for a cylinder internal unit is provided, which includes a first expanding structure arranged at an end of an internal unit and a second expanding structure arranged on a side wall of the internal unit. The first expanding structure includes a plurality of first expanding assemblies arranged at the end of the internal unit through a base. A central axis of the base coincides with a central axis of the internal unit, and the plurality of first expanding assemblies are arranged at intervals in a circumferential direction of the base. The second expanding structure includes a plurality of second expanding assemblies arranged on the side wall of the internal unit. The plurality of second expanding assemblies are arranged at intervals in the circumferential direction of the internal unit.

In some practicable implementations, the first expanding assembly includes: a press block mounted on the base through a compression screw and configured to move close to the base under an external force of tightening the compression screw; and a slide block abutting on a side wall of the press block away from the central axis of the internal unit and configured to be driven by the press block so as to be displaced in a direction away from the central axis of the base. The press block includes a first inclined surface, and the first inclined surface is a contact surface of the press block contacting with the slide block and is inclined towards the slide block.

In some practicable implementations, the base is provided with a first slide rail, and the slide block is slidably arranged on the first slide rail.

In some practicable implementations, the first expanding structure further comprises a first looseproof member. The slide block is provided with a first step hole, and a length direction of the first step hole is the same as a sliding direction of the slide block. One end of the first looseproof member is arranged on the base and the other end of the first looseproof member is arranged in the first step hole.

In some practicable implementations, a side of the slide block away from the press block has an arc surface, and circles where the arc surfaces of the slide blocks of the plurality of first expanding assemblies are located coincide with each other.

In some practicable implementations, the first step hole includes a first through hole and a second through hole, and the first through hole and the second through hole are waist-shaped holes, and a width of the first through hole is less than a width of the second through hole. The first looseproof member is a bolt, a threaded rod of the first looseproof member is located in the base and the first through hole, and a head of the first looseproof member is located in the second through hole. A diameter of the head of the first looseproof member is larger than a diameter of the threaded rod of the first looseproof member.

In some practicable implementations, there are two first step holes, and the two first step holes are symmetrically arranged at two sides of the first slide rail.

In some practicable implementations, there are two press blocks, and the two press blocks are symmetrically arranged at two sides of the first slide rail.

In some practicable implementations, a number of the first expanding structure is one or two. In a case that there are two first expanding structures, the two first expanding structures are symmetrically arranged at two ends of the internal unit.

In some practicable implementations, the second expanding assembly includes a mounting strip, an expanding strip and a tensioning piece. The mounting strip is provided on the side wall of the internal unit, and an extension direction and a length of the mounting strip are the same as those of the internal unit, and a length of the mounting strip is the same as a length of the internal unit. The expanding strip is arranged on the mounting strip through a second looseproof member, and an extension direction of the expanding strip is the same as the extension direction of the mounting strip, the expanding strip is provided with a second step hole, one end of the second looseproof member is connected with the internal unit and the other end of the second looseproof member is stopped in the second step hole. The tensioning piece is arranged on the base and configured to drive the expanding strip to move in a direction away from the mounting strip under an external force.

In some practicable implementations, the expanding structure further includes a mounting hole provided at an end of the internal unit, the tensioning piece is inserted in the mounting hole, and an end of the tensioning piece is arranged on the expanding strip. The mounting strip is provided thereon with a support block, and the support block is arranged between the mounting strip and the expanding strip. A side wall of the expanding strip facing towards the mounting strip is provided with a second inclined surface, and the second inclined surface is inclined in a direction towards the tensioning piece. The support block is provided with a third inclined surface, the second inclined surface abuts against the third inclined surface, and an inclination angle and an inclination direction of the second inclined surface are the same as those of the third inclined surface.

In some practicable implementations, the expanding strip further includes a straight segment and a groove segment that are connected to each other. An end of the straight segment away from the groove segment is connected with the second inclined surface, and the groove segment is arranged between the second inclined surface and the tensioning piece. The support block includes a protrusion end extending along the straight segment towards the groove segment, and a projection of the protrusion end in a direction of the tensioning piece is located in the groove segment.

In some practicable implementations, the mounting hole is arranged in a wall surface of the end of the internal unit, and an extension direction of the mounting hole is the same as the extension direction of the expanding strip. The tensioning piece is a draw-in bolt, and an aperture of the mounting hole is larger than an outer diameter of the tensioning piece.

In some practicable implementations, the mounting hole is provided in the base, and an extension direction of the mounting hole is the same as the extension direction of the expanding strip. The tensioning piece is a draw-in bolt, and an aperture of the mounting hole is larger than an outer diameter of the tensioning piece.

In some practicable implementations, the mounting hole is a waist-shaped hole, and a length direction of the mounting hole is the same as a height direction of the second step hole.

In some practicable implementations, the tensioning piece includes a cam and a rotating shaft. The cam is arranged on the mounting strip, and the cam is located between the mounting strip and the expanding strip. One end of the rotating shaft is arranged on the cam and the other end of the rotating shaft is arranged on the base. A central axis of the rotating shaft is parallel to the central axis of the internal unit. The mounting strip is provided with a mounting groove extending circumferentially, and the cam is located in the mounting groove.

In some practicable implementations, the tensioning piece is a pull rod and a link rod. The pull rod is arranged on the base, and the link rod is rotatably connected between the pull rod and the expanding strip. The base is provided with a second slide rail, an extension direction of the second slide rail is the same as the extension direction of the mounting strip, and the pull rod is arranged on the second slide rail.

In some practicable implementations, an end of the mounting strip is connected with the base.

In some practicable implementations, the second step hole includes a third through hole and a fourth through hole. The third through hole and the fourth through hole are waist-shaped holes, and a width of the third through hole is less than a width of the fourth through hole. The second looseproof member is a bolt, a threaded rod of the second looseproof member is located in the internal unit and the third through hole, and a head of the second looseproof member is located in the fourth through hole. A diameter of the head of the second looseproof member is larger than a diameter of the threaded rod of the second looseproof member.

A cylinder internal unit provided according to a second aspect of this application includes an internal unit, a first expanding structure arranged at an end of the internal unit, and a second expanding structure arranged on a side wall of the internal unit. The first expanding structure includes a plurality of first expanding assemblies arranged at the end of the internal unit through a base. A central axis of the base coincides with a central axis of the internal unit, and the plurality of first expanding assemblies are arranged at intervals along a circumferential direction of the base. The second expanding structure includes a plurality of second expanding assemblies arranged on the side wall of the internal unit. The plurality of second expanding assemblies are arranged at intervals along the circumferential direction of the internal unit.

In the expanding structure for the cylinder internal unit and the cylinder internal unit provided according to this disclosure, the expanding structure includes a first expanding structure arranged at an end of the internal unit and a second expanding structure arranged on a side wall of the internal unit. The first expanding structure includes a plurality of first expanding assemblies arranged at the end of the internal unit through a base. A central axis of the base coincides with a central axis of the internal unit, and the plurality of first expanding assemblies are arranged at intervals along a circumferential direction of the base. The second expanding structure includes a plurality of second expanding assemblies arranged on the side wall of the internal unit, and the plurality of second expanding assemblies are arranged at intervals in the circumferential direction of the internal unit. The expanding structure provided in this application can achieve the strength required for expanding with coordination of the first expanding structure and the second expanding structure, and can achieve uniform expansion in the expanding process, which may prevent the screw from getting stuck. In addition, the expanding structure is easy to be assembled and disassembled, the operation is simple, which effectively improve the operation efficiency.

### BRIEF DESCRIPTION OF THE DRAWINGS

In order to illustrate the technical solutions of the present application in details, a brief description of the drawings used for the embodiments is given below. It is apparent that other drawings may be obtained by those skilled in the art, based on these drawings, without making creative efforts.

FIG. 1 is a structural schematic diagram of an expanding structure for a cylinder internal unit according to some embodiments of this application.

FIG. 2 is a structural schematic diagram of a first expanding structure according to some embodiments of this application.

FIG. 3 is a sectional view of a first expanding assembly according to some embodiments of this application.

FIG. 4 is a sectional view of a first step hole according to some embodiments of this application.

FIG. 5 is a structural schematic diagram of a second expanding structure according to some embodiments of this application.

FIG. 6 is a sectional view of a second expanding structure according to some embodiments of this application.

FIG. 7 is a partial enlarged view of portion D in FIG. 6.

FIG. 8 is a first schematic diagram showing a rotational state of a cam and a rotating shaft according to some embodiments of this application.

FIG. 9 is a second schematic diagram showing a rotational state of a cam and a rotating shaft according to some embodiments of this application.

FIG. 10 is a structural schematic diagram of a pull rod and a link rod according to some embodiments of this application.

FIG. 11 is a sectional view of a second step hole according to some embodiments of this application.

### DESCRIPTION FOR THE DRAWINGS

10—first expanding structure; 11—first expanding assembly; 111—press block; 111a—first inclined surface; 112—compression screw; 113—slide block; 113a—first step hole; a1—first through hole; a2—second through hole; 12—base; 121—first slide rail; 13—first looseproof member; 20—second expanding structure; 21—second expanding assembly; 211—mounting strip; 212—expanding strip; 212a—second step hole; a3—third through hole; a4—fourth through hole; 212b—second inclined surface; 212c—straight segment; 212d—groove segment; 213a—draw-in bolt; 213b1—cam; 213b2—rotating shaft; 213c1—pull rod; 213c2—link rod; 214—second looseproof member; 215—support block; 215a—third inclined surface; 215b—protrusion end; 30—mounting hole; 200—internal unit.

### DETAILED DESCRIPTION OF THE EMBODIMENTS

The technical solutions of this application will be described in detail in combination with figures mentioned in embodiments of this application. Apparently, the embodiments described herein are only part, but not all, of embodiments of this disclosure. All other embodiments obtained by those skilled in the art based on the embodiments of this application without creative labor fall within the protection scope of this application.

Herein, the terms “first” and “second”, and the like, are used for descriptive purposes only and are not to be understood as indicating or implying relative importance or implicitly indicating the number of technical features indicated. Thus, a feature defined with the “first” or “second” may explicitly or implicitly means including one or more of said features. In the description of this application, “multiple” or “a plurality of” means two or more, unless otherwise expressly specified.

In addition, in this application, the orientation terms such as “up”, “down”, “inside”, “outside” are defined with respect to the illustrative orientation of the components placed in the attached drawings. It should be understood that these orientation terms are relative concepts, and they are used for description and clarification, and may be varied accordingly with the change of the orientation of the components placed in the attached drawings.

The underwater communication and underwater monitoring technology have developed rapidly in recent years, and they typically employ underwater products for achieving communication or monitoring operations.

The underwater product generally includes an internal unit and an external pressure-bearing cylinder. The internal unit is provided with an expanding structure for supporting the internal unit within the external pressure-bearing cylinder. After the internal unit is placed in the external pressure-bearing cylinder, it needs to adjust the gap between the internal unit and the pressure-bearing cylinder. The provision of the expanding structure facilitates ensuring that the internal unit is evenly supported in the pressure-bearing cylinder.

The underwater product is usually in a thick-walled cylindrical structure to ensure mechanical strength and corrosion resistance. The expanding structure, as connection between the internal unit composed of internal core components of the underwater equipment and the external pressure-bearing cylinder, is especially important.

The existing expanding structure generally needs to be symmetrically arranged at two ends of the internal unit to meet the expanding conditions. In the expanding process, the screw is easily stuck if one side is unevenly stressed, which will affect the expanding effect. In addition, the existing expanding structure is difficult to be assembled and disassembled, which affects the operation efficiency.

In order to solve the above technical problem, it is provided according to embodiments of this application an expanding structure for a cylinder internal unit, which can achieve uniform expansion at the end and side wall of the internal unit in the expanding process, is easy to be disassembled and assembled and is simple for operation. Thus the operation efficiency can be efficiently improved.

FIG. 1 is a structural schematic diagram of an expanding structure for a cylinder internal unit according to some embodiments of this application.

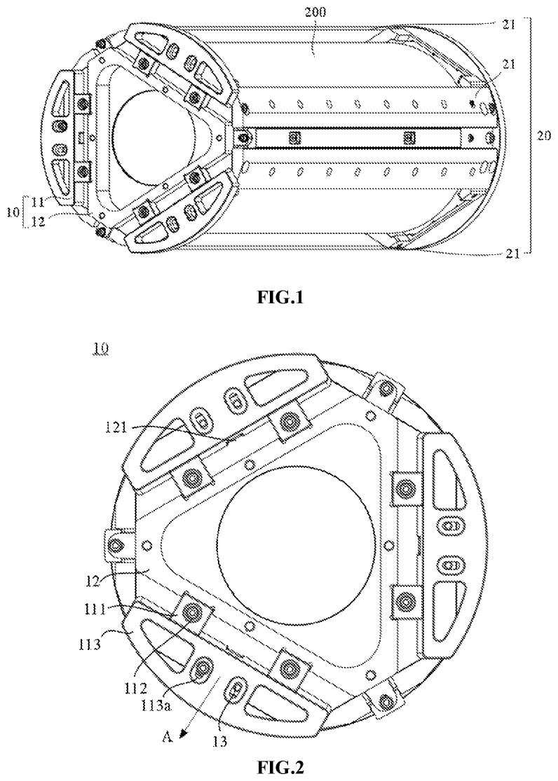

FIG. 2 is a structural schematic diagram of a first expanding structure according to some embodiments of this application.

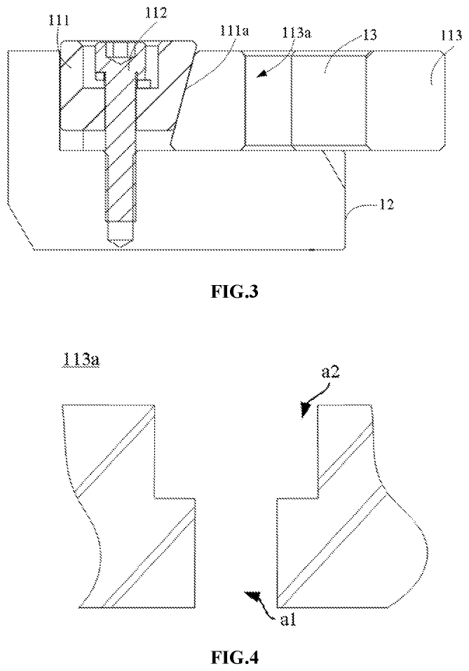

FIG. 3 is a sectional view of a first expanding assembly according to some embodiments of this application.

Referring to FIG. 1, FIG. 2 and FIG. 3, the expanding structure for the cylinder internal unit includes a first expanding structure 10 and a second expanding structure 20.

The first expanding structure 10 is arranged at an end of an internal unit 200, and the first expanding structure 10 is configured for expanding the end of the internal unit 200.

Specifically, the first expanding structure 10 includes a plurality of first expanding assemblies 11 arranged at an end of the internal unit 200 through a base 12. The base 12 may be fixedly mounted to the end of the internal unit 200 through a bolt. A central axis of the base 12 coincides with a central axis of the internal unit 200, and the plurality of first expanding assemblies 11 are arranged at intervals along a circumferential direction of the base 12.

In this way, the base 12 provides a mounting base for the plurality of first expanding assemblies 11. Thus, uniform expanding of the end of the internal unit 200 can be achieved with the plurality of first expanding assemblies 11.

Continuing with FIG. 2, the first expanding assembly 11 includes a press block 111 and a slide block 113.

In particular, the press block 111 is mounted to the base 12 through a compression screw 112. The press block 111 may be a block structure with an inclined surface. The compression screw 112 may be mounted at a middle position of the press block 111. During the process of tightening the compression screw 112, the press block 111 may be moved close to the base 12 together with the compression screw 112, and a distance between a bottom of the press block 111 and a top of the base 12 is gradually reduced. The press block 111 includes two side walls, one side wall is close to the central axis of the internal unit 200 and the other side wall is away from the central axis of the internal unit 200. The press block 111 includes a first inclined surface 111a, which is a contact surface between the press block 111 and the slide block 113. The first inclined surface 111a is the side wall of the press block away from the central axis of the internal unit 200.

During the mounting process, the compression screw 112 may firstly be mounted on the press block 111, and then on the base 12. In this way, in the process of gradually tightening the compression screw 112 into the base 12, the press block 111 may be moved with the compression screw 112, and the distance between the pressing block 111 and the base 12 is gradually reduced.

It should be noted that, the number of the first expanding assemblies 11 shown in FIG. 2 is three, and the three first expanding assemblies 11 are evenly distributed in the circumferential direction of the base 12. The above is only an example to show that the number of the first expanding assemblies 11 is three, which is not intend to limit the number of the first expanding assemblies 11. In other implementations, the number of the first expanding assemblies 11 may be two, four, five or more. The number of the first expanding assemblies 11 may be changed based on shape and size of the practical internal unit 200, and is not limited herein.

Continuing with FIGS. 2 and 3, the slide block 113 may have a petal structure, with one side being a planar structure and the other side being a curved-surface structure. The side of the planar structure abuts on the side wall of the press block 111 away from the central axis of the internal unit 200, and the side of the curved-surface structure is away from the press block 111.

The planar structure of slide block 113 may be an inclined planar structure. Thus, the first inclined surface 111a of the press block 111 abuts against the inclined planar structure of the slide block 113, and inclination angles and inclination directions of the first inclined surface 111a and the inclined planar structure are the same. In this way, in the process of the press block 111 being driven downward by the compression screw 112, the press block 111 may push the slide block 113 to move away from the central axis of the base 12 through the first inclined surface 111a.

Specifically, the base 12 is provided with a first slide rail 121. The slide block 113 moves along the first slide rail 121 away from the central axis of the base 12 during the sliding process. A central axis of the first slide rail 121 may coincide with a radius of the base 12, and the first slide rail 121 extends in the direction away from the central axis of the base 12.

In one specific implementation, the side of the slide block 113 away from the press block 111 has an arc surface, and circles where the arc surfaces of the plurality of slide blocks 113 are located coincide with each other. Thus, in the process of pushing the slide block 113 by the press block 111, the multiple slide blocks 113 move synchronously towards the direction away from the central axis of base 12. A sliding distance of the slide block 113 may be adjusted through a moving distance of the press block 111 pushed by the compression screw 112, and an increment of a radius of the circle where the arc surface is located may be controlled based on the sliding distance of the slide block 113, so as to achieve a required size for expanding the end. Apparently, the slide block 113 with the arc surface is suitable for an internal unit 200 with a circular cross section in this implementation. In other implementations, the shape of the slide block 113 may be changed based on the shape of the internal unit 200. For example, if the shape of the internal unit 200 is a cube, the side of the slide block 113 away from the press block may be a plane, and the planes of the multiple slide blocks 113 may form a cube structure.

FIG. 4 is a sectional view of a first step hole provided according to an embodiment of this application.

Continuing with FIGS. 3 and 4, the first expanding structure 10 further includes a first looseproof member 13. The slide block 113 is provided with a first step hole 113a, and the first looseproof member 13 is arranged in the first step hole 113a. A central axis of the first step hole 113a is parallel to the central axis of the base 12. A length direction of the first step hole 113a is the same as the sliding direction of the slide block 113 and the extension direction of the first slide rail 121.

The first step hole 113a includes a first through hole a1 and a second through hole a2. The first through hole a1 is arranged closer to the base 12. The first through hole a1 and the second through hole a2 may both be waist-shaped holes, and a width of the first through hole a1 is less than a width of the second through hole a2.

Taking the first expanding assembly 11 shown in FIG. 2 as an example, the slide block 113 may be pushed by the press block 111 to move in the direction A, the first slide rail 121 extends along the direction A, and the length direction of the first step hole 113a is the direction A.

In a specific implementation, the first looseproof member 13 may be a bolt, one end of the first looseproof member 13 may be a threaded rod, and the other end of the first looseproof member 13 may be a head. The threaded rod of the first looseproof member 13 may be located in the base 12 and in the first through hole a1, and the head of the first looseproof member 13 may be located in the second through hole a2.

In a specific implementation, the number of the first step holes 113a is two and the number of the press blocks 111 is two. The two first step holes 113a are symmetrically arranged at two sides of the first slide rail 121, and the two press blocks 111 are symmetrically arranged at two sides of the first slide rail 121. The two press blocks 111 may be located at outer sides of the two first step holes 113a. The slide block 113 may further include two hollow structures that are arranged corresponding to the press blocks 111. The provision of the hollow structures can effectively reduce the overall weight of the first expanding structure 10 on the premise of meeting the structural strength of the slide block 113.

The number of the first expanding structures 10 may be one or two. When there is one first expanding structure 10, the first expanding structure 10 is arranged at a left or right side of the internal unit 200, so as to achieve single-end expanding of the internal unit 200. When there are two first expanding structures 10, the two first expanding structures 10 may be symmetrically arranged at two sides of the internal unit 200, so as to achieve two-end expanding of the internal unit 200.

The working process of the first expanding structure 10 is described below.

In the process of tightening the compression screw 112, the compression screw 112 drives the press block 111 to move towards the top of the base 12, with the distance between the press block 111 and the top of the base 12 gradually reduced. In this process, the first inclined surface 111a of the press block 111 pushes the slide block 113, such that the slide block 113 is moved along the first slide rail 121 towards the direction away from the central axis of the base 12. The first looseproof member 13 located in the first step hole 113a can limit the maximum sliding displacement of the slide block 113 during the movement of the slide block 113. In the sliding process of the slide block 113, the first step hole 113a is driven, with the slide block 113, to move relative to the first looseproof member 13, such that a distance between the first looseproof member 13 and an end of the first step hole 113a away from the press block 111 is gradually increased, while a distance between the first looseproof member 13 and an end of the first step hole 113a close to the press block 111 is gradually reduced. When the slide block 113 is moved to a position of the maximum displacement, the first looseproof member 13 will abut against the wall of the first step hole 113a close to the press block 111, thereby preventing the slide block 113 from moving further and thus preventing the slide block 113 from falling off. The plurality of first expanding assemblies 11 work simultaneously, such that the plurality of slide blocks 113 can be expanded outward uniformly around the circumferential direction of the base 12, which ensures the expansion effect as well as the uniformity of expansion.

The first expanding structure 10 provided according to the embodiments of this application can be mounted in a narrower space and can be applied to internal units 200 of various shapes. The internal unit 200 may be of a regular shape such as a cylindrical shape or a polygon shape, or of an irregular shape such as a special shape. The height of the press block 111 can be controlled via the compression screw 112, so as to control the slide block 113 to slide along the first slide rail 121. During the expansion operation, the heights of the multiple press blocks 111 may be adjusted to be the same, and the compression screws 112 are moved downward to push the slide blocks 113 so as to cause outward sliding distance of each slide block 113 to be the same, thereby achieving uniform expansion and meeting the requirements of supporting and fastening. In addition, when the first expanding assembly 11 is to be removed, the compression screw 112 and the first looseproof member 13 may be removed, and thus the slide block 113 can be removed from the narrow space. Therefore the first expanding assembly is easy to be disassembled and assembled, the operation is simple, and the operation efficiency is efficiently improved.

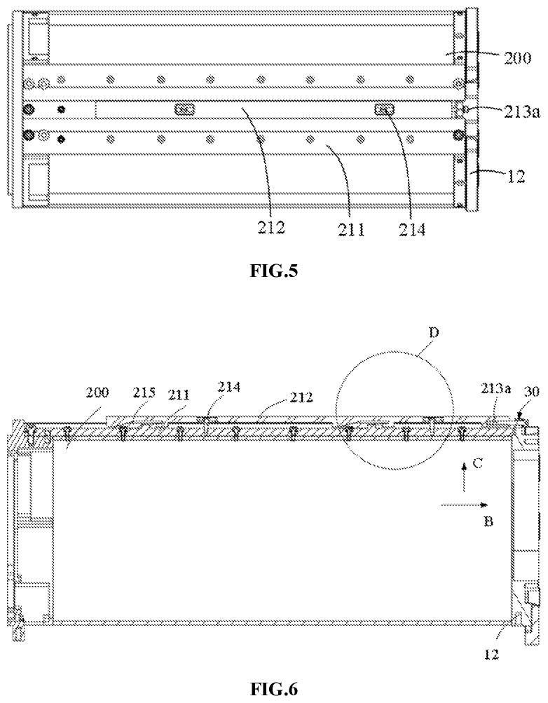

FIG. 5 is a structural schematic diagram of a second expanding structure according to some embodiments of this application.

FIG. 6 is a sectional view of a second expanding structure according to some embodiments of this application.

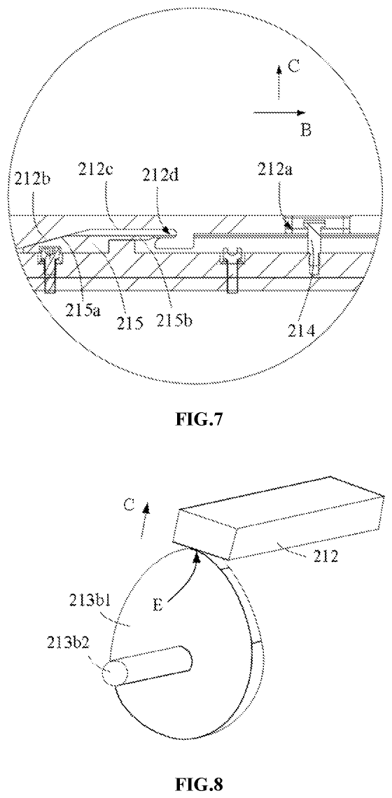

FIG. 7 is a partial enlarged view of portion D shown in FIG. 6.

Referring to FIGS. 1, 5, 6 and 7, the second expanding structure 20 includes a plurality of second expanding assemblies 21 arranged on the side wall of the internal unit 200 at intervals in the circumferential direction of the internal unit 200. The plurality of second expanding assemblies 21 are configured for expansion operation of the side wall of the internal unit 200.

The second expanding assembly 21 includes a mounting strip 211, an expanding strip 212, a tensioning piece and a second looseproof member 214. The mounting strip 211 may be fixedly connected on the side wall of the internal unit 200 through a screw, and an extension direction and a length of the mounting strip 211 may be the same as those of the internal unit 200. The mounting strip 211 may be in a configuration which has a groove at the middle portion thereof, and a support block 215 is provided in the groove. The expanding strip 212 may be arranged on the mounting strip 211 through the second looseproof member 214, and an extension direction of the expanding strip 212 is the same as the extension direction of the mounting strip 211. The expanding strip 212 is provided with a second step hole 212a, one end of the second looseproof member 214 is connected with the internal unit 200 and the other end of the second looseproof member 214 is stopped in the second step hole 212a. One end of the second looseproof member 214 may be fixedly connected to the wall surface of the internal unit 200 and the other end of the second looseproof member 214 may be stopped in the second step hole 212a, so as to stop the expanding strip 212 from falling off through the second looseproof member 214.

Specifically, the extension direction of the expanding strip 212 is the same as the extension direction of the mounting strip 211, and central axes of the mounting strip 211, the expanding strip 212 and the internal unit 200 are in the same plane.

The tensioning piece is arranged on the base 12 and configured to drive the expanding strip 212 to move in a direction away from the mounting strip 211 under an external force, to thereby achieve expanding of the side wall of the internal unit 200.

In a specific implementation, the expanding structure of the cylinder internal unit further includes a mounting hole 30. The mounting hole 30 is provided at an end of the internal unit 200. The tensioning piece is inserted in the mounting hole 30, and one end of the tensioning piece is arranged on the expanding strip 212. The tensioning piece may be a draw-in bolt 213a. One end of the expanding strip 212 may be arranged on the mounting strip 211 through the draw-in bolt 213a. The draw-in bolt 213a is inserted in the mounting hole 30, one end of the draw-in bolt 213a may be connected with the expanding strip 212, while the other end of the draw-in bolt 213a is held at an outer side of the mounting hole 30 away from the expanding strip 212. The draw-in bolt 213a is locked in the expanding strip 212 under an external force. During the process of locking the draw-in bolt 213, the expanding strip 212 may move towards a direction away from the mounting strip 211, to thereby achieve expanding operation of the side wall of the internal unit 200.

Specifically, the mounting strip 211 is provided with a support block 215. The support block 215 is located between the mounting strip 211 and the expanding strip 212. The expanding strip 212 is provided, at a side wall thereof towards the mounting strip 211, with a second inclined surface 212b, and the second inclined surface 212b is inclined in a direction towards the draw-in bolt 213a. The support block 215 is provided with a third inclined surface 215a having the same inclination angle and inclination direction as the second inclined surface 212b. The second inclined surface 212b and the third inclined surface 215a are contact surfaces of the expanding strip 212 and the support block 215, respectively.

In this way, by providing the second inclined surface 212b and the third inclined surface 215a abutted with each other, when the draw-in bolt 213a is locked to the expanding strip 212 so as to cause the expanding strip 212 to move in a direction away from the mounting strip 211, the expanding strip 212 may slide along the third inclined surface 215a and thus has displacements in directions B and C as shown in FIG. 6. The direction B may be the axial direction of the internal unit 200, and the direction C may be a radial direction of the internal unit 200.

The expanding strip 212 further includes a straight segment 212c and a groove segment 212d that are connected to each other. An end of the straight segment 212c away from the groove segment 212d is connected with the second inclined surface 212b. That is, the straight segment 212c is arranged between the second inclined surface 212b and the groove segment 212d, and the groove segment 212d is arranged between the straight segment 212c and the draw-in bolt 213a.

The support block 215 includes a protrusion end 215b. The third inclined surface 215a extends along the straight segment 212c towards the groove segment 212d, thereby forming the protrusion end 215b, and a projection of the protrusion end 215b in the direction towards the draw-in bolt 213a is located in the groove segment 212d. In this way, after the expanding operation is completed, when the locking force between the draw-in bolt 213a and the expanding strip 212 is reduced under an external force, the expanding strip 212 may slide along the third inclined surface 215a in opposite directions of B and C to the initial position. At this time, a distance between the protrusion end 215b and the groove segment 212d gradually decreases until the protrusion end 215b completely enters the groove segment 212d, thereby avoiding the expanding strip 212 from falling off in the direction of gravity after the expanding operation is completed.

In this way, during the process that the draw-in bolt 213a is locked to the expanding strip 212, the draw-in bolt 213a and the expanding strip 212 are displaced in the direction B synchronously, such that the draw-in bolt 213a moves a certain distance within the mounting hole 30 in the direction B.

An inner diameter of the mounting hole 30 is greater than an outer diameter of the draw-in bolt 213a. The mounting hole 30 may be a round hole or a waist-shaped hole.

Specifically, the mounting hole 30 may be provided in the wall surface of the internal unit 200, or provided in the base 12. An extension direction of the mounting hole 30 is the same as the extension direction of the expanding strip 212.

In a specific implementation, the mounting hole 30 may be a waist-shaped hole, with a length direction of the mounting hole 30 being the same as a height direction of a second step hole 212a.

FIG. 8 is a first schematic diagram illustrating a rotational state of a cam and a rotating shaft according to some embodiments of this application.

FIG. 9 is a second schematic diagram illustrating a rotational state of a cam and a rotating shaft according to some embodiments of this application.

Refer to FIGS. 8 and 9, in another specific implementation, the tensioning piece may be in the form of a cam 213b1 and a rotating shaft 213b2.

Specifically, the cam 213b1 may be arranged vertically between the mounting strip 211 and the expanding strip 212, and a rotation plane of the cam 213b1 is in contact with the mounting strip 211 and the expanding strip 212. The mounting strip 211 may be provided thereon with a mounting groove extending circumferentially, and the cam 213b1 is arranged in the mounting groove and is rotatable in the mounting groove relative to the mounting strip 211 and the expanding strip 212.

One end of the rotating shaft 213b2 is arranged on the cam 213b1 and the other end of the rotating shaft 213b2 is arranged on the base 12, and a central axis of the rotating shaft 213b2 is parallel to the central axis of the internal unit 200.

In other words, in the process of performing the expanding operation through the second expanding assembly 21, the cam 213b1 may be driven to rotate by the rotating shaft 213b2. Due to characteristics of the cam 213b1 itself, a top E on the side wall of the cam 213b1 that is farther away from the rotating shaft 213b2 will push up the expanding strip 212 during rotation of the cam 213b1, such that the expanding strip 212 is moved in the direction away from the mounting strip 211, to thereby achieved radial expanding.

It should be noted that the other end of the rotating shaft 213b2 may be mounted on the base 12 through a bearing. Alternatively, the rotating shaft 213b2 may be mounted on the base 12 in other forms or through other components, which is not limited herein.

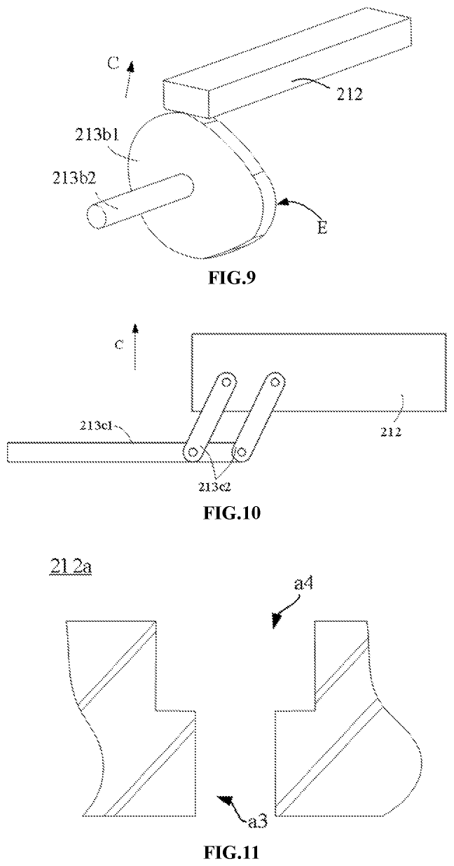

FIG. 10 is a structural schematic diagram of a pull rod and a link rod according to some embodiments of this application.

Referring to FIG. 10, in another specific implementation, the tensioning piece may be in the form of a pull rod 213c1 and a link rod 213c2.

Specifically, the base 12 is provided with a second slide rail (not shown in the drawings). An extension direction of the second slide rail is the same as the extension direction of the mounting strip 211. A side of the pull rod 213c1 facing towards the base 12 is provided with a slide rail groove to be cooperated with the second slide rail. The pull rod 213c1 may be arranged on the second slide rail of the base 12 through the slide rail groove, and be slidable relative to the base 12. In the process of pushing the pull rod 213c1, the pull rod 213c1 can push the expanding strip 212 through the link rod 213c2 to cause the expanding strip 212 to displace radially, so as to achieve radial expanding.

In FIG. 10, the number of the link rods 213c2 is two, and two ends of each link rod 213c2 are hinged with the expanding strip 212 and the pull rod 213c1, respectively. Of course, the number of the link rods 213c2 is not limited to two. In other implementations, the number of the link rod(s) 213c2 may be one, three or more. In addition, the link rod 213c2 may be connected with the expanding strip 212 and the pull rod 213c1 in other forms, as long as both ends of the link rod 213c2 are rotationally connected with the expanding strip 212 and the pull rod 213c1, respectively, which are not limited herein.

It should be noted that the number of the second expanding assemblies 21 shown in FIG. 1 is three, and the three second expanding assemblies 21 are evenly distributed on the side wall of the internal unit 200. The above is only an example to show that the number of the second expanding assemblies 21 is three, and is not intend to limit the number of the second expanding assemblies 21. In other implementations, the number of the second expanding assemblies 21 may be two, four, five or more. The number of the second expanding assemblies 21 may be changed based on the shape and size of the specific internal unit 200, and is not limited herein. The number of the support block(s) 215 and the number of the looseproof member(s) 214 in the second expanding assembly 21 may be changed based on actual axial size of the internal unit 200.

FIG. 11 is a sectional view of a second step hole according to some embodiments of this application.

Referring to FIG. 11, the second step hole 212a includes a third through hole a3 and a fourth through hole a4. The third through hole a3 and the fourth through hole a4 are both waist-shaped holes, and a width of the third through hole a3 is less than a width of the fourth through hole a4. The third through hole a3 is closer to the mounting strip 211, while the fourth through hole a4 is farther away from the mounting strip 211.

The second looseproof member 214 may be a bolt. A threaded rod of the second looseproof member 214 may be located in the internal unit 200 and the third through hole a3, a head of the second looseproof member 214 may be located in the fourth through hole a4, and a diameter of the head is greater than a diameter of the threaded rod, which thus can prevent the expanding strip 212 in a loose state from falling off the internal unit 200.

In a specific implementation, an end of the mounting strip 211 may be mounted on the base 12. The mounting strip 211 may be located between any two adjacent slide blocks 113. In this way, the mounting space can be used rationally. Of course, in other implementations, the end of the mounting strip 211 may be mounted at a position that is not connected to the base 12.

The working process of the second expanding structure 20 is described below by taking a case in which the tensioning piece in the second expanding structure 20 is a draw-in bolt 213a as an example.

For example, the tensioning piece is a draw-in bolt 213a, the mounting hole 30 is provided in the base 12, and the mounting hole 30 is a waist-shaped hole. The draw-in bolt 213a is passed through the mounting hole 30, one end of the draw-in bolt with threads may be connected with the expanding strip 212 through threads, and the other end is held outside the base 12. When it is needed to perform the expanding operation of the side wall of the internal unit 200, the end of the draw-in bolt 213a outside the mounting hole 30 is tightened. As the expanding strip 212 is limited by the second looseproof member 214 and thus cannot rotate, the expanding strip 212 tends to move obliquely upward along the second inclined surface 212b under the external force, i.e., the expanding strip 212 will be displaced in the directions B and C. As the expanding strip 212 is displaced in the direction C, the expanding strip 212 drives the draw-in bolt 213a to move synchronously. In this way, the tensioning piece, together with the expanding strip 212, will be displaced in the direction C along the length direction of the mounting hole 30. In this process, as the expanding strip 212 is displaced in the direction B, a distance between an end of the expanding strip 212 and the mounting hole 30 gradually decreases, and the distance between the protrusion end 215b and the groove segment 212d gradually increases.

After the expanding operation of the side wall of the internal unit 200 is completed, the draw-in bolt 213a may be loosened in an opposition direction to cause the tightening force between the draw-in bolt 213a and the expanding strip 212 to be reduced, the distance between the expanding strip 212 and the mounting hole 30 is gradually increased, and the expanding strip 212 slides along the second inclined surface 212b in directions opposite to the directions B and C. During this process, the distance between the protrusion end 215b and the groove segment 212d gradually decreases, and the protrusion end 215b gradually enters into the groove segment 212d. Even if the draw-in bolt 213a is moved out of the expanding strip 212, the expanding strip 212 will not fall off in the direction of gravity.

For the second expanding structure 20 provided according to this application, a plurality of second expanding assemblies 21 are uniformly distributed along the axial direction of the internal unit 200. During the expanding operation, the expanding strip 212 is pulled by the draw-in bolt 213a and is moved along the radial direction and the axial direction of the internal unit 200, until the expanding strip 212 abuts against the external pressure-bearing cylinder. With the provision of the second looseproof member 214, it can effectively prevent the expanding strip 212 in a loose state from falling off from the internal unit 200. In addition, a backbending guidance is provided for the expanding strip 212, which can provide guidance during radial expansion as well as ensuring the protrusion end 215b of the support block 215 being in the groove segment 212d during radial retraction to prevent the expanding strip 212 from falling off due to the action of gravity. When it needs to disassemble the second expanding assemblies 21, one may only disassemble the draw-in bolt 213a and the second looseproof member 214 so as to remove the expanding strip 212.

The working process of the second expanding structure 20 is described below by taking a case in which the tensioning piece in the second expanding structure 20 includes a cam 213b1 and a rotating shaft 213b2 as an example.

When it needs to perform the expanding operation of the side wall of the internal unit 200, the rotating shaft 213b2 is rotated, and the cam 213b1 is driven to rotate by the rotating shaft 213b2. During the process that the top E of the cam 213b1 is rotated in a direction close to the expanding strip 212, the expanding strip 212 is continuously pushed up and is displaced in the direction C, until the top E of the cam 213b1 contacts the expanding strip 212, at this time, the displacement of the expanding strip 212 in the direction C is the largest and the radial expanding is completed. When it needs that the expanding strip 212 fall back, it only needs to rotate the cam 213b1 continuously or rotate the cam 213b1 in the opposite direction such that the top E is moved away from the expanding strip 212.

The working process of the second expanding structure 20 is described below by taking a case in which the tensioning piece in the second expanding structure 20 includes a pull rod 213c1 and a link rod 213c2 as an example.

When performing the expanding operation of the side wall of the internal unit 200, the pull rod 213c1 is pushed, the pull rod 213c1 in turn pushes the link rod 213c2, and the link rod 213c2 pushes the expanding strip 212 to move. During the movement of the expanding strip 212, the expanding strip 212 is continuously pushed up by the link rod 213c2, and thus has a displacement in the direction C, until the pull rod 213c1 is moved to a limit position, where the displacement of the expanding strip 212 in the direction C is the largest, and then the radial expanding is completed. It only needs to pull the pull rod 213c1 to cause the pull rod 213c1 to return to its initial position, when it is needed that the expanding strip 212 falls back.

The expanding structure provided in this application can achieve the required strength of expanding with cooperation of the first expanding structure 10 and the second expanding structure 20. In this way, uniform expanding can be achieved in the expanding process, and it is not easy for the screw to get stuck. In addition, the expanding structure is easy to be disassembled and assembled, the operation is simple, which can effectively improve the operation efficiency.

It is also provided according to some embodiments of this application a cylinder internal unit which includes the internal unit 200 and the first expanding structure 10 and the second expanding structure 20 provided in the above embodiments. The first expanding structure 10 is provided at an end of the internal unit 200. The first expanding structure includes a plurality of first expanding assemblies 11 disposed at the end of the internal unit 200 through a base 12. A central axis of the base 12 coincides with a central axis of the internal unit 200, and the plurality of first expanding assemblies 11 are arranged at intervals in a circumferential direction of the base 12. The second expanding structure 20 is provided on a side wall of the internal unit. The second expanding structure 20 includes a plurality of second expanding assemblies 21 arranged on the side wall of the internal unit 200. The plurality of second expanding assemblies 21 are arranged at intervals in a circumferential direction of the internal unit 200.

The cylinder internal unit provided according to this application can achieve the required strength for the expanding with coordination of the first expanding structure 10 and the second expanding structure 20 during operation. In this way, uniform expanding can be achieved in the expanding process, and it is not easy to have the screw stuck. In addition, the expanding structure is easy to be disassembled and assembled, the operation is simple, which effectively improves the operation efficiency.

It should be noted that, persons skilled in the art, after considering the description and implementing the application disclosed herein, will easily conceive of other implementations of this application. Therefore, this application is intended to cover any variation, use or adaptation of this application that follows the general principle of this application and includes common knowledge or customary techniques in the technical field that are not disclosed in this application. The description and embodiments are to be regarded as exemplary only, and the protection scope of this application is indicated by the claims.

It should be noted that this application is not limited to the precise structures described above and shown in the attached drawings, and various modifications and changes may be made without deviating from the scope of this application. The scope of this application is limited only by the attached claims.

What is claimed is:

1. An expanding structure for a cylinder internal unit, comprising:
a first expanding structure (10) arranged at an end of an internal unit, the first expanding structure (10) comprising:
a plurality of first expanding assemblies (11) arranged at the end of the internal unit through a base (12), wherein a central axis of the base (12) coincides with a central axis of the internal unit, and the plurality of first expanding assemblies (11) are arranged at intervals in a circumferential direction of the base (12); and
a second expanding structure (20) arranged on a side wall of the internal unit, the second expanding structure (20) comprising:
a plurality of second expanding assemblies (21) arranged on the side wall of the internal unit, wherein the plurality of second expanding assemblies (21) are arranged at intervals in the circumferential direction of the internal unit.

2. The expanding structure for the cylinder internal unit according to claim 1, wherein the first expanding assembly (11) comprises:
a press block (111) mounted on the base (12) through a compression screw (112) and configured to move in a direction closing to the base (12) under an external force of tightening the compression screw (112); and
a slide block (113) abutting against a side wall of the press block (111) away from the central axis of the internal unit and configured to be driven by the press block (111) to displace in a direction away from the central axis of the base (12),
wherein the press block (111) comprises a first inclined surface (111a), the first inclined surface (111a) is a contact surface of the press block (111) contacting with the slide block (113), and the first inclined surface (111a) is inclined towards the slide block (113).

3. The expanding structure for the cylinder internal unit according to claim 2, wherein the base (12) is provided with a first slide rail (121), and the slide block (113) is slidably arranged on the first slide rail (121).

4. The expanding structure for the cylinder internal unit according to claim 3, wherein the first expanding structure (10) further comprises a first looseproof member (13), and the slide block (113) is provided with a first step hole (113a), wherein a length direction of the first step hole (113a) is the same as a sliding direction of the slide block (113), and one end of the first looseproof member (13) is arranged on the base (12) and the other end of the first looseproof member (13) is arranged in the first step hole (113a).

5. The expanding structure for the cylinder internal unit according to claim 4, wherein a side of the slide block (113) away from the press block (111) has an arc surface, and circles where arc surfaces of slide blocks (113) of the plurality of first expanding assemblies are located coincide with each other.

6. The expanding structure for the cylinder internal unit according to claim 4, wherein
the first step hole (113a) comprises a first through hole (a1) and a second through hole (a2), the first through hole (a1) and the second through hole (a2) are waist-shaped holes, and a width of the first through hole (a1) is less than a width of the second through hole (a2);
the first looseproof member (13) is a bolt, wherein a threaded rod of the first looseproof member (13) is located in the base (12) and the first through hole (a1), and a head of the first looseproof member (13) is located in the second through hole (a2), and wherein a diameter of the head of the first looseproof member (13) is larger than a diameter of the threaded rod of the first looseproof member (13).

7. The expanding structure for the cylinder internal unit according to claim 6, wherein there are two first step holes (113a), and the two first step holes (113a) are symmetrically arranged at two sides of the first slide rail (121).

8. The expanding structure for the cylinder internal unit according to claim 6, wherein there are two press blocks (111), and the two press blocks (111) are symmetrically arranged at two sides of the first slide rail (121).

9. The expanding structure for the cylinder internal unit according to claim 1, wherein
a number of the first expanding structure (10) is one or two, and
wherein in a case that there are two first expanding structures (10), the two first expanding structures (10) are symmetrically arranged at two ends of the internal unit.

10. The expanding structure for the cylinder internal unit according to claim 2, wherein the second expanding assembly (21) comprises:
a mounting strip (211) arranged on the side wall of the internal unit, wherein an extension direction of the mounting strip (211) is the same as an extension direction of the internal unit, and a length of the mounting strip (211) is the same as a length of the internal unit;
an expanding strip (212) arranged on the mounting strip (211) through a second looseproof member (214), wherein an extension direction of the expanding strip (212) is the same as the extension direction of the mounting strip (211), the expanding strip (212) is provided with a second step hole (212a), and one end of the second looseproof member (214) is connected with the internal unit and the other end of the second looseproof member (214) is stopped in the second step hole (212a); and
a tensioning piece arranged on the base (12) and configured to drive the expanding strip (212) to move in a direction away from the mounting strip (211) under an external force.

11. The expanding structure for the cylinder internal unit according to claim 10, wherein
the expanding structure further comprises a mounting hole (30), the mounting hole (30) is provided at an end of the internal unit, the tensioning piece is inserted through the mounting hole (30), and an end of the tensioning piece is arranged on the expanding strip (212);
the mounting strip (211) is provided thereon with a support block (215), the support block (215) is arranged between the mounting strip (211) and the expanding strip (212); a side wall of the expanding strip (212) facing towards the mounting strip (211) is provided with a second inclined surface (212b), and the second inclined surface (212b) is inclined towards the tensioning piece; the support block (215) is provided with a third inclined surface (215a), the second inclined surface (212b) abuts against the third inclined surface (215a), and an inclination angle and an inclination direction of the second inclined surface (212b) are the same as those of the third inclined surface (215a), respectively.

12. The expanding structure for the cylinder internal unit according to claim 11, wherein
the expanding strip (212) further comprises a straight segment (212c) and a groove segment (212d) that are connected to each other, an end of the straight segment (212c) away from the groove segment (212d) is connected with the second inclined surface (212b), and the groove segment (212d) is arranged between the second inclined surface (212b) and the tensioning piece;
the support block (215) comprises a protrusion end (215b) extending along the straight segment (212c) towards the groove segment (212d), and a projection of the protrusion end (215b) in a direction of the tensioning piece is located in the groove segment (212d).

13. The expanding structure for the cylinder internal unit according to claim 11, wherein
the mounting hole (30) is provided in a wall surface of the end of the internal unit, and an extension direction of the mounting hole (30) is the same as the extension direction of the expanding strip (212), wherein the tensioning piece is a draw-in bolt (213a), and an aperture of the mounting hole (30) is larger than an outer diameter of the tensioning piece.

14. The expanding structure for the cylinder internal unit according to claim 11, wherein
the mounting hole (30) is provided in the base (12), and an extension direction of the mounting hole (30) is the same as the extension direction of the expanding strip (212), wherein the tensioning piece is a draw-in bolt (213a), and an aperture of the mounting hole (30) is larger than an outer diameter of the tensioning piece.

15. The expanding structure for the cylinder internal unit according to claim 13, wherein
the mounting hole (30) is a waist-shaped hole, and a length direction of the mounting hole (30) is the same as a height direction of the second step hole (212a).

16. The expanding structure for the cylinder internal unit according to claim 10, wherein
the tensioning piece comprises a cam (213b1) and a rotating shaft (213b2), the cam (213b1) is arranged on the mounting strip (211) and is located between the mounting strip (211) and the expanding strip (212); one end of the rotating shaft (213b2) is arranged on the cam (213b1) and the other end of the rotating shaft (213b2) is arranged on the base (12), and a central axis of the rotating shaft (213b2) is parallel to the central axis of the internal unit;
wherein the mounting strip (211) is provided with a mounting groove extending circumferentially, and the cam (213b1) is located in the mounting groove.

17. The expanding structure for the cylinder internal unit according to claim 10, wherein
the tensioning piece comprises a pull rod (213c1) and a link rod (213c2), wherein the pull rod (213c1) is arranged on the base (12), and the link rod (213c2) is rotatably connected between the pull rod (213c1) and the expanding strip (212);
the base (12) is provided with a second slide rail, an extension direction of the second slide rail is the same as the extension direction of the mounting strip (211), and the pull rod (213c1) is arranged on the second slide rail.

18. The expanding structure for the cylinder internal unit according to claim 11, wherein an end of the mounting strip (211) is connected with the base (12).

19. The expanding structure for the cylinder internal unit according to claim 11, wherein
the second step hole (212a) comprises a third through hole (a3) and a fourth through hole (a4), the third through hole (a3) and the fourth through hole (a4) are waist-shaped holes, and a width of the third through hole (a3) is less than a width of the fourth through hole (a4);
the second looseproof member (214) is a bolt, a threaded rod of the second looseproof member (214) is located in the internal unit and the third through hole (a3), and a head of the second looseproof member (214) is located in the fourth through hole (a4), wherein a diameter of the head of the second looseproof member (214) is larger than a diameter of the threaded rod of the second looseproof member (214).

20. A cylinder internal unit, comprising:
an internal unit (200);
a first expanding structure (10) arranged at an end of the internal unit (200), wherein the first expanding structure (10) comprises a plurality of first expanding assemblies (11), the plurality of first expanding assemblies (11) are arranged at the end of the internal unit through a base (12), and wherein a central axis of the base (12) coincides with a central axis of the internal unit, and the plurality of first expanding assemblies (11) are arranged at intervals in a circumferential direction of the base (12);
a second expanding structure (20) arranged on a side wall of the internal unit (200), wherein the second expanding structure (20) comprises a plurality of second expanding assemblies (21), the plurality of second expanding assemblies (21) are arranged on the side wall of the internal unit, and are arranged at intervals in the circumferential direction of the internal unit.
